(19) United States
(12) Patent Application Publication
(10) Pub. No.: US 2021/0205906 A1
(43) Pub. Date: Jul. 8, 2021

(54) POLE MILL OPTIMIZER

(71) Applicant: POLE MILL OPTIMIZER LLC, Wiggins, MS (US)

(72) Inventors: LENFIELD RICHY O'NEAL, WIGGINS, MS (US); WILLIAM BRADFORD BREWER, SAUCIER, MS (US); DOUGLAS STEVEN WALLER, SAUCIER, MS (US)

(73) Assignee: POLE MILL OPTIMIZER LLC, WIGGINS, MS (US)

(21) Appl. No.: 15/998,923

(22) PCT Filed: Feb. 16, 2017
(86) PCT No.: PCT/US2017/018098

§ 371 Date: Aug. 16, 2018

Related U.S. Application Data
(60) Provisional application No. 62/295,886, filed on Feb. 16, 2016.

(51) Int. Cl. B23D 59/00; B27B 1/00

(52) U.S. Cl. CPC B23D 59/001; B23D 59/008; B27B 1/007

(57) ABSTRACT

Classing and inspecting poles and pilings is a manual process that, due to human error, results in inaccurate, inconsistent products and a waste of resources. An automated method and device for inspecting and classing poles and pilings and keeping a real-time inventory comprising a conveyance system, pole profiler, counting wheel encoders, cutting device, control console, and real-time database provides a more accurate product in less time and at a lower cost.

### CROSS-REFERENCE TO RELATED APPLICATIONS

This application claims the benefit of U.S. Provisional Application No. 62/295,866 filed Feb. 16, 2016, which is incorporated herein by reference in its entirety.

### FIELD OF THE INVENTION

The present invention is generally directed toward a method and device for classing and inspecting poles and pilings.

### BACKGROUND OF THE INVENTION

The pole manufacturing process encompasses the conversion of raw materials into finished products, and the accuracy and profitability of the process hinges on the extent to which the process it optimized. Currently, the process of pole and piling classing and inspecting is almost entirely manual and has many areas of fault and human error.

More specifically, after the initial pole or piling product is peeled, the length of the product is determined by an individual eyeballing the end of the pole in comparison to markings on the carriage system from normally a distance of 70′-80′ away as the product is rolled from the peeling area. Classing the product currently consists of a tree scaling tape measure that is wrapped at a distance of 3′ or 6′ from the base of the product to determine the circumference and the overall class is determined based on the length and circumference. The top circumference of the pole from the top length also is used to class and often causes the product to be reclassed to a lower class. A classed product must not have greater than a 1″ sweep per 10′. Again, this measurement is determined visually as the product is passed in front of the inspector and is often missed due to human error.

Cutting the product is done with the use of a radial, chop or bar saw. This is in most cases engaged by the inspector based on a visual placement of the product or saw blade. Often times more or less of the product is removed causing the product to be rejected by the client upon delivery.

Further, use of general aerosol spray paint for demarcation and identification causes is another way that an inspector can miscall the product and can cause problems for the client when trying to read these markings. Many times the paint is smeared or even missing due to moisture being present when the markings are created. These markings are used at multiple stages of the product's life, beginning with placement on the yard or warehouse.

Any of the numerous errors that logically result from the manual processes discussed above can cause the product to be rejected and/or the value to be reduced. Additionally, these manual processes require excessive employee resources related to training and on-site labor. These issues have been generally accepted in the industry, with the loss of monetary value being viewed as part of the general business loss. Although there have been attempts to solve this problem, hard stops created throughout the mill cannot be easily added, as many mills have been compiled in stages over numerous years. Additional solutions have been proposed in the lumber industry, which are tailored specifically to that industry, thereby failing to solve the aforementioned issues associated with the pole industry.

### SUMMARY OF THE INVENTION

Classing and inspecting poles and pilings is currently almost entirely manual resulting in numerous human errors and increased cost. The presently disclosed invention is a method and device that guides a peeled product through the classing and inspection process comprising a pole conveyance system, control console, pole profiler, and counting wheel encoders. This device can fit into any size mill and be easily configured through the digital interface, thus significantly reducing human error and increasing efficiencies. More specifically, the present invention provides a more accurate and consistent product created in less time at less cost.

### BRIEF DESCRIPTION OF THE DRAWINGS

Further advantages of the invention will become apparent by reference to the detailed description of preferred embodiments when considered in conjunction with the drawings;

FIG. 1 depicts a block diagram of the system of the device.

FIG. 2 depicts a left side view of the control console of the device.

FIG. 3 depicts a front view of the control console of the device.

FIG. 4 depicts a right side view of the control console of the device.

FIG. 5 depicts a perspective view of the laser sensor pole profiler of the device.

FIG. 6 depicts a diagram of the laser sensors of the device.

FIG. 8 depicts display of the control FIG. 7 depicts a tag created by a printing device of an embodiment of the system.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Manually inspecting and classing poles and pilings produces excessive quantities of rejected pole and piling products and value lost due to inefficiencies that logically result from a manual process. A need exists for a large scale automated process that requires less employee resources related to training and on-site labor. The proposed method and device is an automated classing and inspecting process specific to the pole industry which keeps a real-time inventory and provides a more accurate product in less time and at a lower cost.

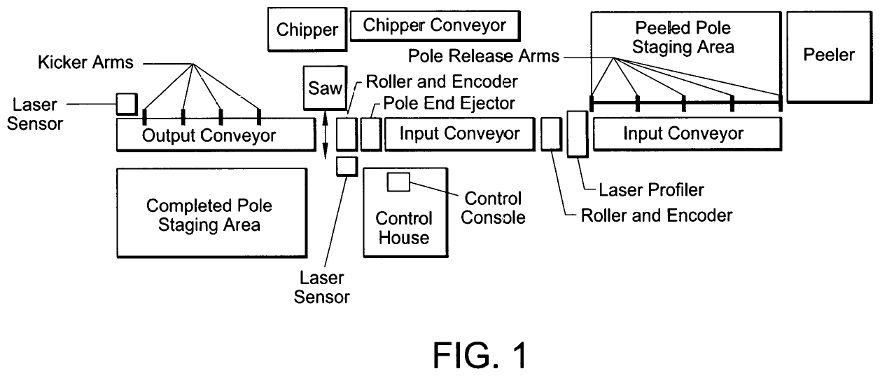

As shown in FIG. 1, the present invention is a device and method for guiding a large scale peeled product through the classing and inspecting process comprising a pole profiler measuring pole circumference and providing pole profile data, counting wheel encoders for measuring pole length and position for cutting, a cutting device, a marking device, and a control console for logic and data collection. This approach can be configured to fit in any size mill and easily configured through the digital interface, thus significantly reducing human error and increasing efficiencies.

In the preferred embodiment of the invention, the process automated by the device begins after the pole product leaves the peeling area of the mill and is delivered to the classing and inspecting unit to be staged and enter the pole conveyance system. The pole conveyance system is comprised of an input conveyor stage and final output conveyor stage. Once the pole product enters the classing and inspecting unit via the input conveyer stage, it enters a first counting wheel encoder which is responsible for measuring the product as it travels through the optimizer ring of the counting wheel encoder. The optimizer ring determines both circumference and sweep of the pole. This information is stored in the control console as length, circumference, and X/Y per inch to be used later in the process.

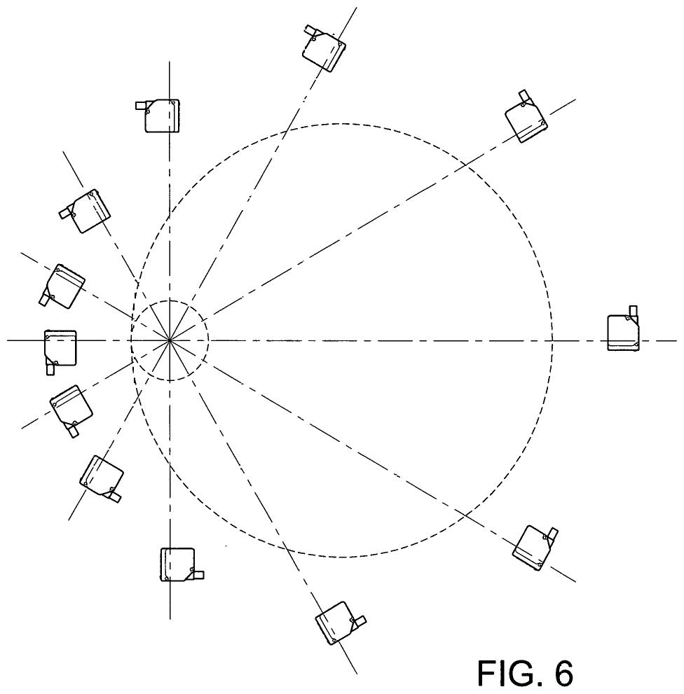

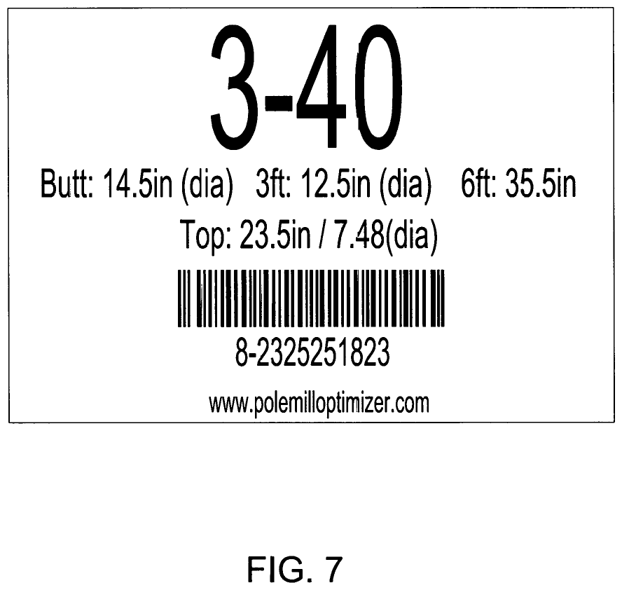

At this input conveyor stage of the pole conveyance system, a potential embodiment of the invention includes using a laser profiler laser array as shown in FIG. 5 to measure pole circumference and length and provide pole profile data. The laser assembly is free standing with a wiring junction box and can be mounted in line with the pole conveyance system. As shown in FIG. 6, the laser profiler includes numerous laser sensors which will provide for feedback signals to the control house for circumference calculation and can include a data display. The lasers take numerous measurements including, without limitation, loop control, thickness, roll diameter, position, error, and part presence from 100 mm up to 10000 mm. To simplify replacement and repair, the laser sensors are connected with cables. This potential embodiment increases reliability and accuracy for challenging targets with excessive attached limbs and other debris.

A potential embodiment of the invention includes modifying the height of the pole product after it is measured in the input conveyor stage of the pole conveyance system.

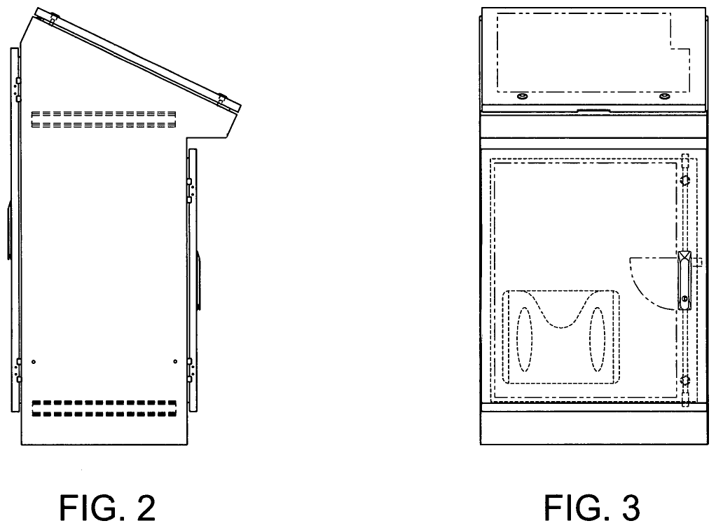

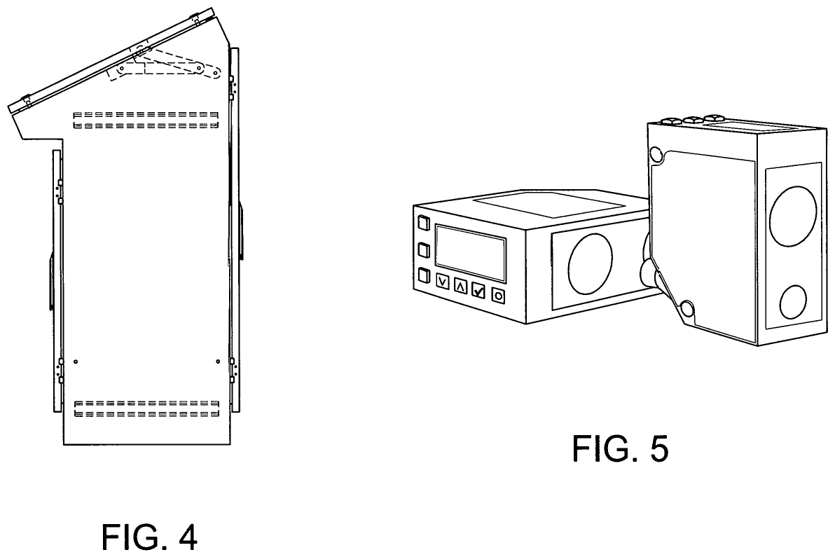

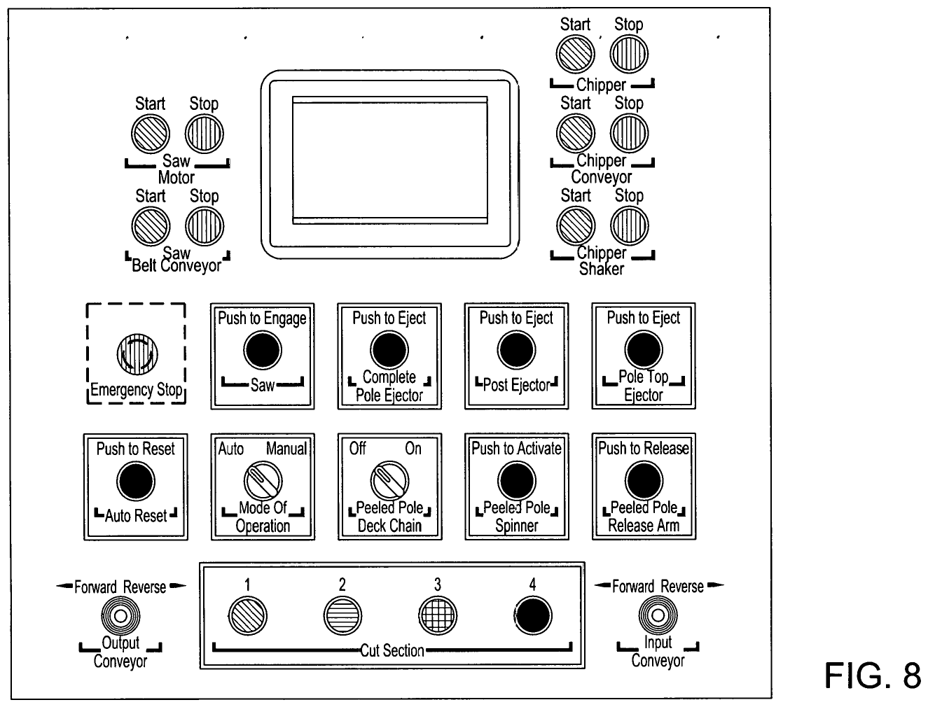

After the pole product passes through the optimization ring of the first counting wheel encoder, the measurement data collected is transmitted to the control house containing the control console as shown in FIGS. 2-4. The display of the control console has buttons than can be pushed by an inspector to start and stop the numerous processes of the device as shown in FIG. 8.

For instance, the control console display may contain buttons to start and stop the saw motor, saw belt conveyor, chipper conveyor, and chipper shaker. It also may contain buttons to eject a pole, post, or pole top. The buttons may include an automatic or manual selection of the mode of operation and may have the option to forward or reverse the input or output conveyor and turn on and off the peeled pole deck chain. Also, the inspector may push buttons on the control console to activate a peeled pole spinner or push to release a peeled pole release arm. Finally, the control console display may contain an emergency stop and auto reset button. These buttons are just an example of the many selections that can be made by the control console of the device.

Next, the pole product is classed to size. The sizes are determined based on a matrix of overall length and circumference at 3′ and 6′ and 1-3′ from the top based on individual company requirements of the pole product. The size designations can be controlled by individuals in an office, by manual input on the control console, or automatically setting the height of the pole. For instance, the inspector can choose one of the sizing options by pressing the corresponding size button on the control console in the control house. Sizing is determined by numerous factors, including, but not limited to, client need, surplus, or general need of product.

After passing through the input conveyor of the pole conveyance system, the pole product can be culled due to flaws in the pole product, such as to many visual knots, splits, or data-based info like sweep exceptions.

During the cutting phase, the pole product is moved against a saw so that 3″ is removed from the base of the tree to remove any damage that may have been caused when the product was harvested and to create a smooth, flat base.

While 3″ is the preferred length removed from the base of the pole product, any length is contemplated which results in a smooth, flat base.

Potential embodiments of the invention include using a circular radial saw, circular chop saw, and bar saw in sizes of 4′, 5′ and 6′.

Once the pole product passes the saw, a second counting wheel encoder is activated upon contact to handle the final cut of the top of the pole product. The input from the second counting wheel encoder feeds the current length of the product minus the distance from the saw to determine when the pole conveyance system should stop and the saw should be engaged. Once the final cut is made, the pole product continues to travel down to a markings system where the class, length and any additional information is marked on the base of the pole product and can also be added to the top or any other location on the pole product as needed.

A potential embodiment of the marking system includes utilization of two different printing devices to mark and tag the end of the pole product. The first printing device is a direct ink system that marks the side of the pole/piling, and second printing device is a tagging system that creates a tag for specific inventory of the product. An example of the tag created by the second printing device is shown in FIG. 7.

Once the pole product has completed the process, the database is updated by adding the pole product to the product inventory for the specific size and class. The database is used to track, among other metrics, inventory sales and movement of the pole product within the pole mill, as well as, to a client. The method provides a more accurate and consistent product to the client and greatly reduces the number of rejected and reduced value poles and pilings.

A potential embodiment of the method includes software which creates a closed loop inventory of the pole/piling products from inception in the woods to the point of sale to the client.

Another potential embodiment of the method includes using cameras to monitor the process for quality and control maintenance. The camera can be included in the control console display depicted in FIG. 8.

While the present device and method was created for classing and inspecting pole and piling products, any other large scale item that can be similarly classed and inspected is contemplated by the present invention.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A device for guiding a peeled pole or piling product through the classing and inspecting process comprising:
a. a conveyance system for moving the pole product through the process;
b. a pole profiler measuring pole circumference and providing pole profile data,
c. counting wheel encoders for measuring pole length and position of the pole for cutting;
d. a cutting device;
e. a control console for logic and data collection of measurements; and
f. a real-time database to track and transmit metrics of the pole product.

2. The device of claim 1 wherein the conveyance system is further comprised of an input conveyor and an output conveyor.

3. The device of claim 1 wherein an array of lasers is used to measure the pole product circumference and length.

4. The device of claim 1 wherein three wheel encoders are utilized throughout the conveyance system.

5. The device of claim 1 wherein the cutting device is a radial saw.

6. The device of claim 1 wherein the cutting device is a circular chop saw.

7. The device of claim 1 wherein the cutting device is a bar saw.

8. The device of claim 1 wherein the real-time database includes a closed-loop software inventory of the pole products.

9. The device of claim 1 wherein printing devices are used to mark and tag the pole product.

10. The device of claim 1 wherein cameras monitor the quality and maintenance of the process.

11. An automated method for classing and inspecting poles and piling products comprising:
a. the pole product entering a conveyance system;
b. measuring the pole product via counting wheel encoders;
c. collecting and transmitting the pole product measurement data to a control house;
d. sizing the pole product;
e. cutting the pole product via a saw; and
f. marking the pole product.

12. The method of claim 11 wherein a laser array measures the length and circumference of the pole product.

13. The method of claim 11 wherein the pole product is sized by an inspector.

14. The method of claim 11 wherein the pole product is automatically sized.

15. The method of claim 11 wherein closed-loop inventory software collects and transmits pole product metrics from origin to the point of sale.

16. The method of claim 11 wherein pole products are culled after measurement due to flaws.

17. The method of claim 11 wherein the pole product is marked via printing devices.

18. The method of claim 11 wherein the height of the pole product is modified after measurement.

19. The method of claim 11 wherein the conveyance system further comprises an input conveyor and output conveyor.
